(19) United States
(12) Patent Application Publication
(10) Pub. No.: US 2025/0121484 A1
(43) Pub. Date: Apr. 17, 2025

(54) DRIVING TOOL

(71) Applicant: MAKITA CORPORATION, Anjo-shi (JP)

(72) Inventors: Nobuyuki HOSHIYAMA, Anjo-shi (JP); Masaya NAGAO, Anjo-shi (JP)

(73) Assignee: MAKITA CORPORATION, Anjo-shi (JP)

(21) Appl. No.: 18/669,767

(22) Filed: May 21, 2024

(30) Foreign Application Priority Data
Oct. 17, 2023 (JP) 2023-178900

(51) Int. Cl. B25F 5/02; B25F 5/00

(52) U.S. Cl. CPC B25F 5/02; B25F 5/001

(57) ABSTRACT

A driving tool has a tool body, a driver that moves downward to strike a driven member, a grip extending rearward from the tool body, a battery mounting section provided at a rear part of the grip to which a battery can be attached, a motor housing extending rearward from the tool body below the grip and accommodating an electric motor that moves the driver, and a controller arranged below the electric motor to control an operation of the electric motor.

### CROSS-REFERENCE TO RELATED APPLICATIONS

This application claims priority to Japanese patent application serial number 2023-178900 filed Oct. 17, 2023, the contents of which are incorporated herein by reference in their entirety for all purposes.

### BACKGROUND

The present disclosure relates to a driving tool for driving a driven member into a workpiece.

Conventional gas spring type driving tool that utilizes a thrust power of compressed air as a driving force has a driver configured to strike a driven member. A lift mechanism allows the driver to return to a stand-by position. An electric motor is used as a drive source for the lift mechanism. The driver, the lift mechanism, and the electric motor are all accommodated in a tool body of the driving tool. A driving nose is provided at a bottom of the tool body. The driven member is ejected from the driving nose. A grip extends from the tool body to the side. A plurality of driven members is loaded in the magazine. The magazine extends from the driving nose substantially toward an extending direction of the grip.

A battery configured to supply power to the electric motor is mounted on the driving tool. The battery mounting section is located at an end of the grip. A flat plate-shaped controller is housed inside the battery mounting section along an upper surface of the battery. The controller controls an operation of, for example, the electric motor. With the conventional controller arrangement, it was difficult to make the driving tool more compact in the driving direction (front-rear direction) of the grip.

Therefore, there is a need for a driving tool that can be made compact as a whole by achieving a compact arrangement of a controller.

### SUMMARY

A driving tool may include a tool body that has a driver that moves downward to strike a driven member. A grip extends rearwardly from the tool body. A battery mounting section is provided at a rear part of the grip to which a battery can be attached. A motor housing extends rearwardly from the tool body below the grip and houses an electric motor that allows the driver to move. A controller is located below the electric motor to control an operation of the electric motor.

The controller is arranged below the electric motor, which is arranged below the battery mounting section. This configuration makes an area around the battery mounting section more compact than, for example, a conventional structure in which a controller is arranged along a mounting surface of a battery to be attached to the battery mounting section. The controller can also be compactly arranged along a lower part of the electric motor. Thus, the entire driving tool may be reduced in size in the front-rear direction.

### BRIEF DESCRIPTION OF THE DRAWINGS

FIG. 1 is a right side view of a driving tool according to a first embodiment with a right housing removed.

FIG. 2 is a vertical sectional view of the driving tool as viewed from right when a driver is in a stand-by position.

FIG. 3 is a vertical sectional view of the driving tool as viewed from right after a driving operation of the driver.

FIG. 4 is a cross-sectional view taken along IV-IV line of FIG. 2.

FIG. 5 is a cross-sectional view taken along V-V line of FIG. 3.

FIG. 6 is a front view of a lower part of a tool body.

FIG. 7 is a left side view of the driving tool.

FIG. 8 is a perspective view of the driving tool with a right housing, a magazine, and a battery removed.

FIG. 9 is a right side view of a driving tool according to a second embodiment, with a right housing removed.

### DETAILED DESCRIPTION

According to one aspect of the present disclosure, a long side of a box-shaped controller extends along the front-rear direction. Therefore, it is possible to reduce the size of the driving tool in the front-rear direction while preventing the driving tool from increasing in size in the up-down direction due to the arrangement of the controller.

According to another aspect of the present disclosure, an elastic member is interposed between one or both of upper and lower surfaces of the controller and the motor housing. The elastic member protects the controller against impacts, for example, during the driving operation or impacts due to rebound immediately after the driving operation. Rebound occurred during or immediately after the driving operation causes the tool body to move upward against the controller or the like that tends to stay put. Therefore, the impact is mainly transmitted from the lower surface side of the controller. By interposing an elastic member on the lower surface side of the controller, the impact from the controller may be suppressed more efficiently.

According to another aspect of the present disclosure, the driving tool has a magazine that accommodates driven members and extends rearward from a lower part of the tool body. The controller locates between the magazine and the electric motor, preferably in a space between a top of the magazine and a bottom of the electric motor. As a result, the area around the battery mounting section may be made compact.

According to another aspect of the present disclosure, a rear surface of the magazine is positioned flush with or in front of a rear surface of the battery that attaches to the battery mounting section. Therefore, the attachable portion of the battery is compacted in the front-rear direction. For example, the controller does not locate within the vicinity of the battery mounting section, even if the battery protrudes rearward from the rear surface of the magazine. Hence, the attachable portion of the battery is compacted by reducing the protrusion of the battery.

According to another aspect of the present disclosure, a nose is provided at a lower part of the tool body and movable in an up-down direction. The nose has an ejection port for the driven members. The nose protrudes downward from the magazine by 40 mm or more when in an upper position. Therefore, for example a long nose can be inserted into a groove when driving driven members into a bottom of the groove. This configuration makes it possible to improve the handling property of the driving tool.

According to another aspect of the present disclosure, the nose has a width of 15 mm or less in at least one direction. For example, when driving driven members into the bottom of a narrow groove, the nose with a narrow width can be inserted into the groove. This configuration improves the handling property of the driving tool.

According to another aspect of the present disclosure, the driving tool has a magazine support that extends from the motor housing along a lateral side of the magazine. Therefore, the lateral side of the magazine can be supported by the magazine support. This provides stable support for a magazine that is long in the front-rear direction.

According to another aspect of the present disclosure, a rear surface of the battery attached to the battery mounting section is inclined forward and upward. Therefore, the flexibility of the battery mounting section can be increased by arranging the controller below the electric motor. Therefore, when placing the driving tool in a position where the rear surface of the battery is in contact with a ground and a front lower part of the nose is oriented toward a top side, interference between the rear end of the magazine and the ground contact surface can be prevented. This configuration makes it possible to improve the handling property of the driving tool.

According to another aspect of the present disclosure, the tool body includes a piston that moves downward together with the driver due to the gas pressure within the cylinder. The tool body further includes a lift mechanism that moves the driver upward to increase the gas pressure so that the controller is compactly arranged in a so-called gas spring type driving tool.

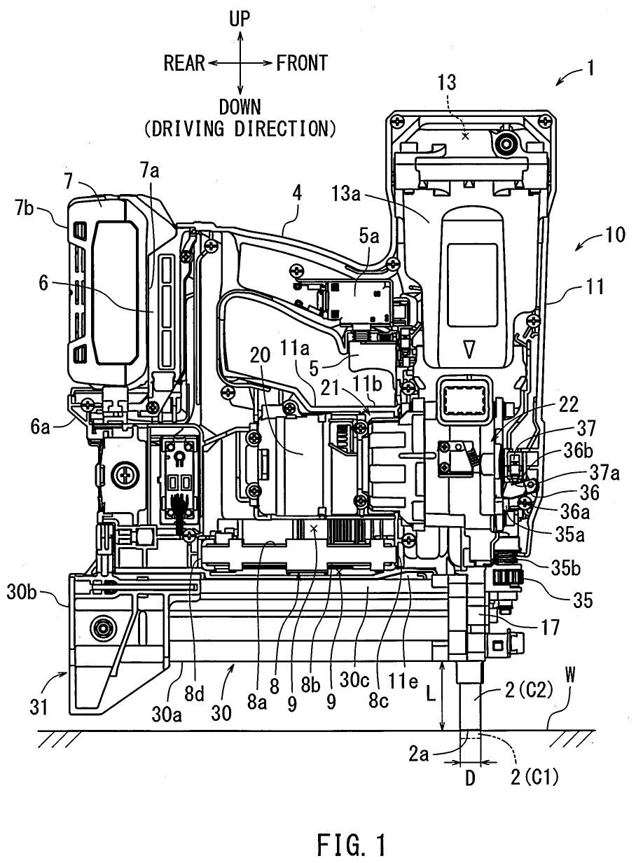

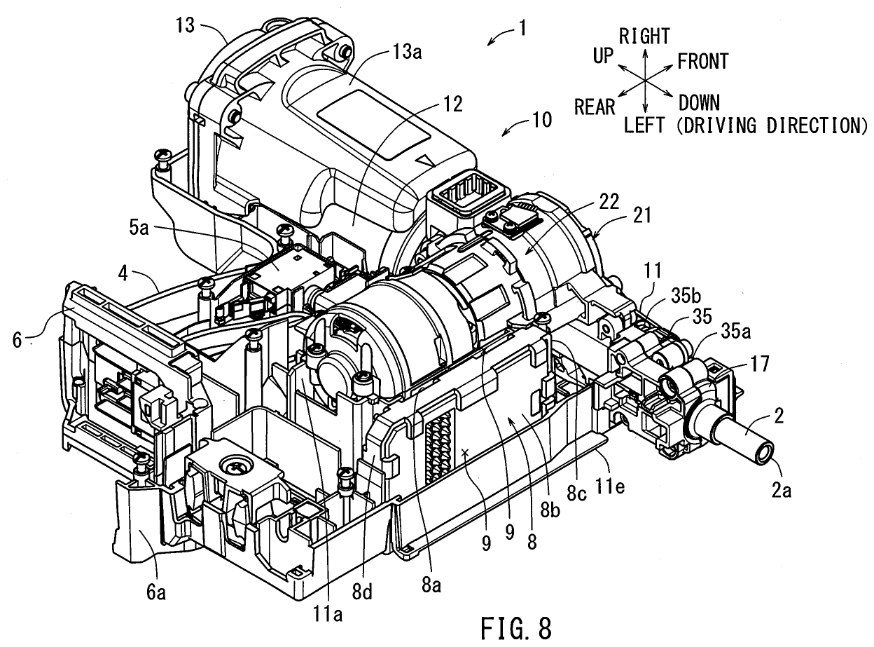

Hereinafter, a first embodiment will be described with reference to FIGS. 1 to 8. As one example of a driving tool 1, a gas spring type driving tool that utilizes gas pressure within a pressure accumulation chamber as a driving force to drive driven members will be exemplary described. In the following description, a driving direction of a driven member is referred to as a downward direction and a counter-driving direction is referred to as an upward direction. A user of the driving tool 1 is positioned substantially to left of the driving tool 1 in FIG. 1. A front side of the user is referred to as a rearward direction, and a side opposite to the front side is referred to as a front direction. Left-right direction is based on the user.

As shown in FIGS. 1 to 3, a driving tool 1 has a tool body 10. The tool body 10 has a substantially cylindrical main body housing 11 configured to accommodate a cylinder 12. A piston 14 is housed in the cylinder 12 so as to reciprocally move up and down. An upper part of the cylinder 12, located above the piston 14 communicates with a pressure accumulation chamber 13. The pressure accumulation chamber 13 is filled with compressed gas, such as air. Gas pressure in the pressure accumulation chamber 13 acts as a thrust force that biases an upper surface of the piston 14 and causes it to move downward.

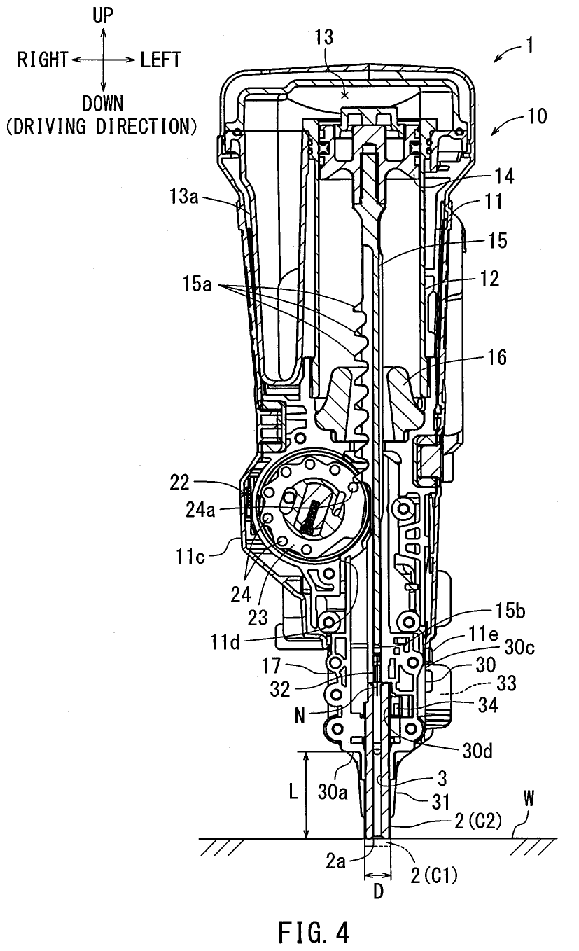

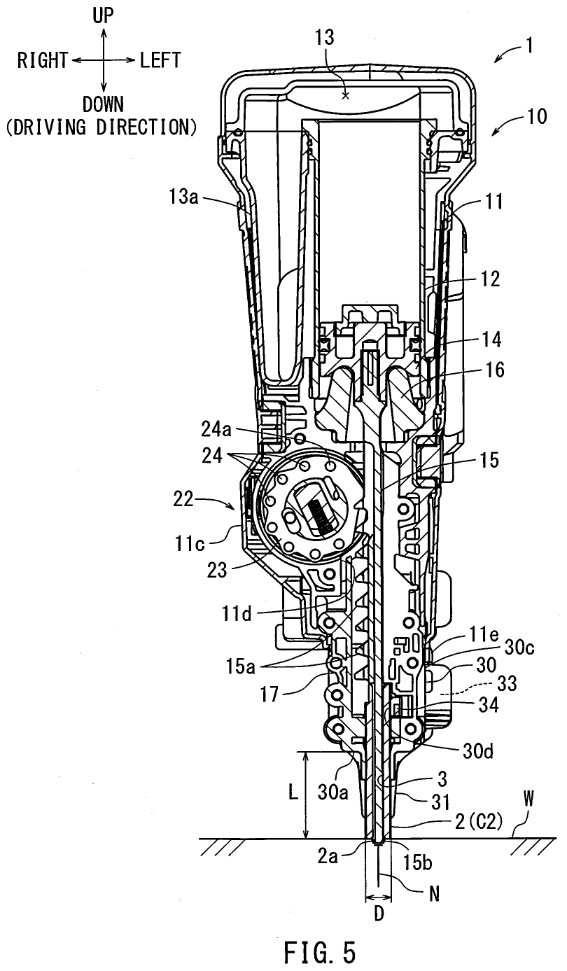

As shown in FIGS. 4 and 5, a right part of the pressure accumulation chamber 13 communicates with an air chamber 13a which extends downward. The air chamber 13a extends downward along a right lateral side of the cylinder 12. The air chamber 13a overlaps with the lift mechanism 22 (described below) in the left-right direction and is provided above the lift mechanism. By providing the air chamber 13a to the right of the cylinder 12, a capacity of the pressure accumulation chamber 13 including the air chamber 13a may be increased while preventing the tool body 10 from becoming larger in the up-down direction.

As shown in FIGS. 1 to 5, a driver guide 17 is provided at a lower part of the tool body 10. A driving nose 2, which comes in contact with the workpiece W, is provided at a lower part of the driver guide 17. The driving nose 2 is provided to have a substantially cylindrical shape and extends in the up-down direction. The driving nose 2 is movable in the up-down direction between a lower position C1 and an upper position C2 with respect to the driver guide 17. The driving nose 2 also serves as a contact arm that detects contact with the workpiece W. The driver guide 17 and driving nose 2 cooperate to form a driving channel 3. The driving channel 3 is formed as a straight passage extending in the up-down direction by an inner circumferential surface of the driver guide 17 and an inner circumferential surface of the driving nose 2. An upper end of the driving channel 3 on the side of the driver guide 17 communicates with a lower part of the cylinder 12.

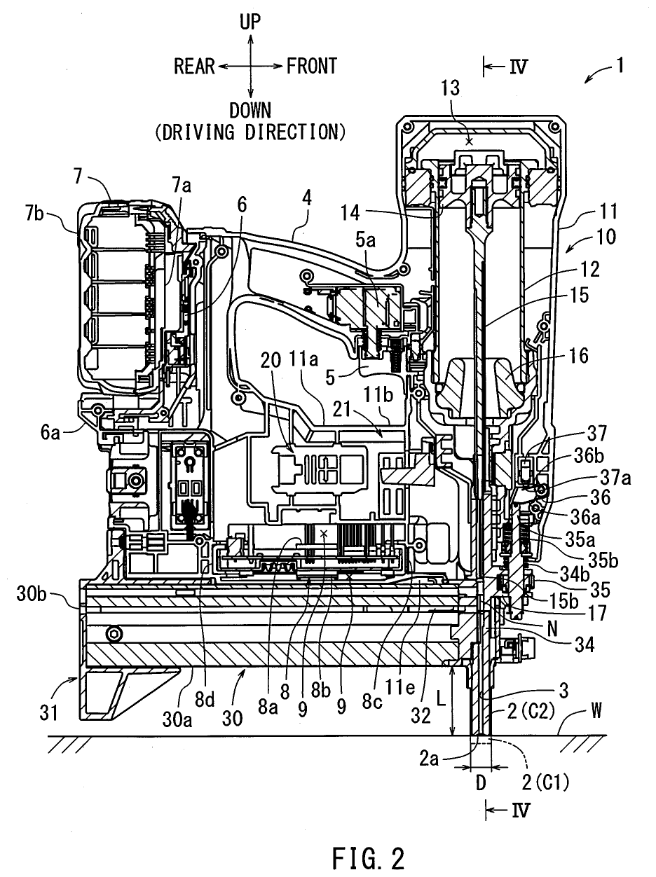

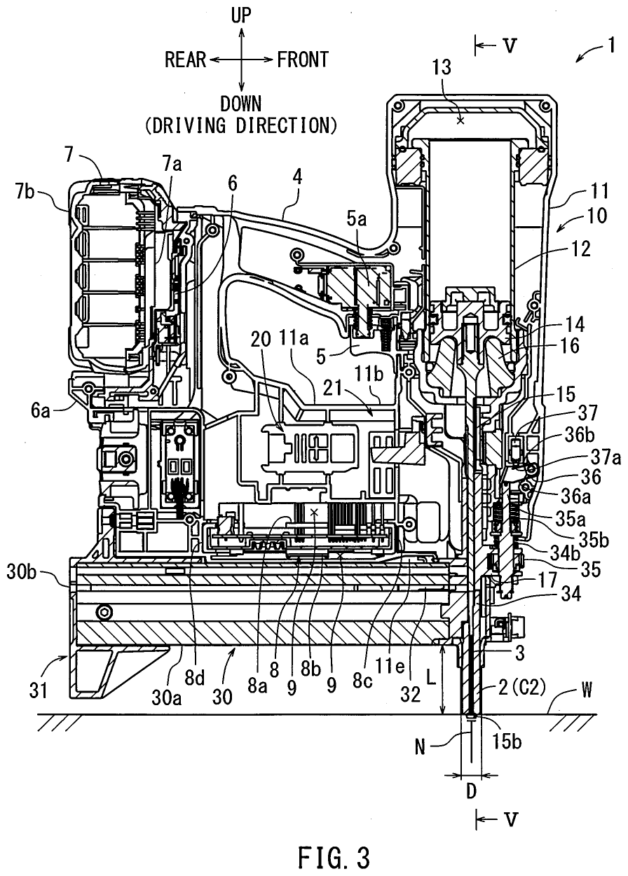

As shown in FIGS. 1 to 3, a magazine 30 is connected to a rear part of the driver guide 17. The magazine 30 extends straight rearward from the driver guide 17 and is formed to have a substantially rectangular box shape. In the magazine 30, a plurality of driven members N is loaded, extending in the up-down direction and aligned in parallel to the front-rear direction. In this embodiment, driven members N may be, for example, nails to be driven into a workpiece W made of concrete. The plurality of driven members N is lined up in the front-rear direction and may be, for example, connected by a connecting member made of resin. The driven members N are fed forward one by one from inside the magazine 30 toward the driving channel 3. FIG. 2 shows the last driven member N in the magazine 30 fed to the driving channel 3 and FIG. 3 shows the driven member N driven into the workpiece W. The figures do not show the state in which the driven member N remains in the magazine 30.

As shown in FIGS. 1 to 3, a grip 4 for a user to grasp extends rearwardly from a rear part of the tool body 10. A trigger 5 is provided on a front lower surface of the grip 4 to allow the user to operate by pulling with the fingertip. A trigger switch 5a is provided inside the grip 4, which switches from OFF state to ON state in response to the pulling operation of the trigger 5. When the driving nose 2 is pressed against the workpiece W and moves from a lower position C1 to an upper position C2, the pulling operation of the trigger 5 becomes effective.

As shown in FIGS. 1 to 3 a battery mounting section 6 extending in the up-down direction is provided on a rear side of the grip 4. A battery 7 is removably attached to the battery mounting section 6. The battery 7 may be removed from the battery mounting section 6 and repeatedly recharged for use with a separately prepared charger. The battery 7 may also be used as a power source for other power tools. The battery 7 supplies electric power to an electric motor 20 or the like, which will be described later. A mounting surface 7a of the battery 7 attached to the battery mounting section 6 extends in an up-down direction, substantially parallel to the driving direction. The battery mounting section 6 has a lower portion 6a extending rearwardly below the battery 7. The lower portion 6a faces a lower surface of the battery 7. Ae rear surface 7b of the battery 7 and a rear surface of the lower portion 6a are substantially flush and aligned up and down. A rear surface 30b of the magazine 30 is substantially flush with the rear surface 7b of the battery 7 and the rear surface of the lower portion 6a, and does not project further rearward at least beyond the rear surface 7b.

As shown in FIGS. 1 to 3, the main body housing 11 has a substantially cylindrical motor housing 11a that extends forward and rearward above the magazine 30 and below the grip 4. A rear part of the motor housing 11a is connected to a lower part of the battery mounting section 6. A substantially cylindrical gear housing 11b having a diameter substantially the same as that of the motor housing 11a is provided in front of the motor housing 11a. A substantially cylindrical lifter housing 11c (see FIG. 4) is provided in front of the gear housing 11b. The motor housing 11a, gear housing 11b, and lifter housing 11c are integrally formed to have a substantially cylindrical shape extending rearward from the tool body 10. A front end of the gear housing 11b is connected to a front part of the main body housing 11. Thus, the grip 4, battery mounting section 6, motor housing 11a, and gear housing 11b cooperate to form a loop shape.

As shown in FIGS. 4 and 5, a long driver 15 in the up-down direction is connected to an underside of the piston 14. A lower part of the driver 15 enters the driving channel 3. The driver 15 moves downward by gas pressure in the pressure accumulation chamber 13 acting on the upper surface of the piston 14. An end 15b located at a lower end of the driver 15 strikes a head of one driven member N fed into the driving channel 3 when the end 15b moves to the driving position. The struck driven member N moves downward through the driving channel 3 and is ejected from an ejection port 2a at a lower end of the driving nose 2. The ejected driven member N is driven into the workpiece W. A substantially cylindrical cushion 16 is provided on an interior bottom side of the cylinder 12 to absorb impact at the bottom dead center of the piston 14.

As shown in FIGS. 4 and 5, a plurality of rack teeth (engaged portions) 15a protruding to right is provided on a right side of the driver 15. In this embodiment, eight rack teeth 15a are arranged in an alignment in the up-down direction, which is a longitudinal direction of the driver 15. Each rack tooth 15a is provided to have a substantially triangular shape with a bottom oriented downward, which is the driving direction, in the front view. The bottom of the rack tooth 15a engages an engaging portion 24 of the lift mechanism 22, which will be described later. A distance in the up-down direction from the bottom of the rack tooth 15a at the lowermost end to the end 15b of the driver 15, may be at least 75 mm, for example, 75 to 90 mm.

As shown in FIGS. 1 to 3, the motor housing 11a accommodates an electric motor 20 as a drive source. The electric motor 20 is accommodated with a motor axis extended in the front-rear direction. The electric motor 20 is started in response to the movement of the driving nose 2 and operation of the trigger 5 using the battery 7 as the power source. A planetary gear reduction mechanism 21 accommodated in the gear housing 11b is provided in front of the electric motor 20. Three planetary gear trains are used in the planetary gear reduction mechanism 21. A lift mechanism 22 accommodated in the lifter housing 11c is provided in front of the planetary gear reduction mechanism 21. The lift mechanism 22 moves the driver 15 and piston 14 upward against the air pressure in the pressure accumulation chamber 13. The electric motor 20, planetary gear reduction mechanism 21, and lift mechanism 22 are arranged in an alignment on the motor axis. The rotational drive of the electric motor 20 is decelerated by the planetary gear reduction mechanism 21 and transmitted to the lift mechanism 22.

As shown in FIGS. 4 and 5, the lift mechanism 22 is provided on the right side of the driving nose 2. The lift mechanism 22 has a wheel 23 rotatable around an axis extending in the front-rear direction. The wheel 23 is rotatable in a counterclockwise direction when viewed from the front and is restricted to rotate in a clockwise direction. A plurality of engaging portions 24 is provided along an outer circumferential edge of the wheel 23. In this embodiment, for example, eight engaging portions 24 are arranged at an interval in the circumferential direction of the wheel 23. The engaging portions 24 may be columnar shaft members (pins) extending in the front-rear direction. As the wheel 23 rotates, each engaging portion 24 moves around the center of rotation of the wheel 23.

As shown in FIGS. 4 and 5, a left portion of the wheel 23 enters the driving channel 3 of driver guide 17 through a window 11d formed in a left part of the lifter housing 11c. Each engaging portion 24 of the wheel 23 engages with the bottom of the rack teeth 15a of the driver 15 in the driving channel 3. The wheel 23 rotates in the counterclockwise direction with at least one of the engaging portions 24 engaged with the bottom of any of the rack teeth 15a. This causes the driver 15 and piston 14 to move upward. The gas pressure in the pressure accumulation chamber 13 increases as the piston 14 moves upward.

As shown in FIGS. 1 to 3 and FIG. 7, the rectangular box-shaped magazine 30 has a lower surface 30a that extends straight in the front-rear direction. The magazine 30 has a rear surface 30b that extends straight in the up-down direction. A magazine cap 31 that defines a rear surface 30b of the magazine 30 is provided at a rear part of the magazine 30. The magazine 30 includes lateral sides 30c extending in a front-rear and up-down direction at each of both left and right sides.

As shown in FIGS. 1 to 3 and FIG. 7, a front end of the magazine 30 connects to a rear part of the driver guide 17. An interior of the magazine 30 communicates with the driving channel 3 of the driver guide 17 through an upper opening 30d (see FIG. 4). A pusher 32 resides within the magazine 30 and loads the driven member N into the driving channel 3. The pusher 32 is a flat plate that extends in an up-down direction and a front-rear direction. A coil spring 33 biases the pusher 32. The coil spring 33 remains in a spring housing on a left lateral side 30c of the magazine 30. A front side of the pusher 32 pushes the driven members N toward the driving channel 3 loading the driven members N one by one into the driving channel 3.

As shown in FIGS. 1 to 6, the driving nose 2 protrudes downward from a lower part of the driver guide 17. The driving nose 2 protrudes downward from a lower surface 30a of the magazine 30 at the upper position C2 by a projection length L. The projection length L is at least 40 mm or more, for example 40 mm to 55 mm. Because of the longer length of the driving nose 2, a location of standby position of the driver 15 is at a lower level. By securing the protruding length L of the driving nose 2 at the upper position C2, for example, the driven member N may be driven into a bottom of a groove formed in the workpiece W. A diameter D of the driving nose 2 may be 15 mm or less, for example, 12 mm. The diameter D corresponds to a width of the driving nose 2 in a direction orthogonal to the up-down direction. By providing the driving nose 2 with a narrow width, the driven member N may be driven into the bottom of a narrow groove formed in the workpiece W.

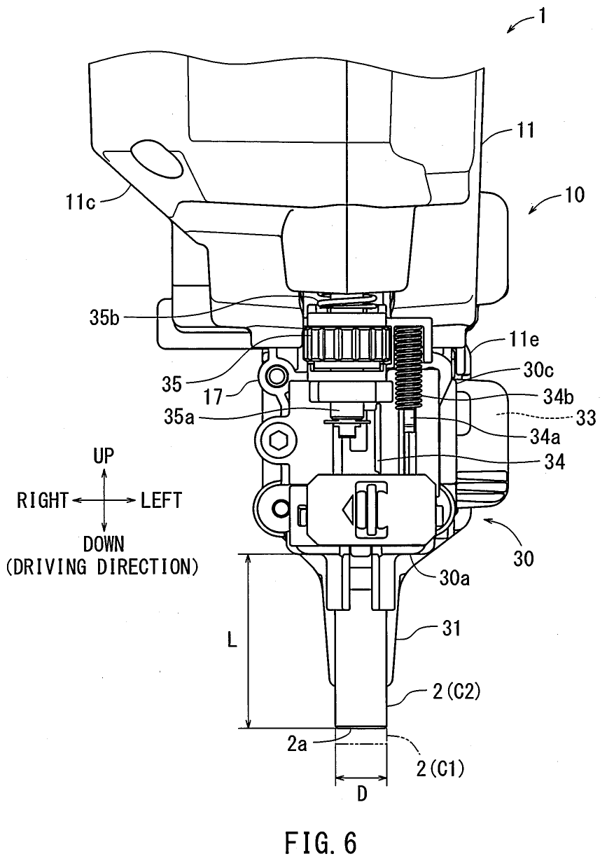

As shown in FIG. 6, the upper part of the driving nose 2 is integrally formed with a contact plate 34. The contact plate 34 is supported to the driver guide 17 so as to be slidable in the up-down direction. The contact plate 34 has a spring receiving portion 34a protruding forward. The spring receiving portion 34a is biased downward by a compression spring 34b supported to the main body housing 11. The driving nose 2 is biased toward the lower position C1 together with the contact plate 34 by the biasing force of the compression spring 34b.

As shown in FIGS. 1 and 6, a dial adjuster 35 is provided in front of the contact plate 34. The adjuster 35 has a rotary shaft 35a extending in the up-down direction. The rotary shaft 35a is rotatably supported on the main body housing 11 and is movable in the up-down direction. The contact plate 34 is connected to the rotary shaft 35a and is movable together in the up-down direction. By rotating the adjuster 35, the upper and lower positions of the contact plate 34 and driving nose 2 may be adjusted. The adjuster 35 has a compression spring 35b that is arranged on the outer circumferential side of the rotary shaft 35a and supported by body-side shaft 11. The compression spring 35b biases the adjuster 35 downward.

As shown in FIGS. 1 to 3, the driving tool 1 has a switch 37 that detects the up-down movement of the driving nose 2. The switch 37 has a protruding pin 37a protruding downward from a rectangular box-shaped switch body. A U-shaped leaf spring 36 is provided between the protruding pin 37a and an upper end of the rotary shaft 35a of the adjuster 35. The U-shaped leaf spring 36 is provided to have a form, in which a lower first piece 36a and an upper second piece 36b are connected at a U-shaped curved section. The U-shaped leaf spring 36 is supported to the main body housing 11 at the curved sections so as to be rotatable in the up-down direction. The first piece 36a contacts the upper end of the rotary shaft 35a. The second piece 36b contacts the protruding pin 37a.

As shown in FIGS. 1 to 3, when the driving nose 2 moves to the upper position C2, the rotary shaft 35a of the adjuster 35 also moves upward via the contact plate 34 (see FIG. 6). The U-shaped leaf spring 36 rotates upward as the first piece 36a is pressed against the upper end of the rotary shaft 35. This causes the second piece 36b to push the protruding pin 37a to turn the switch 37 to the ON state. On the other hand, when the driving nose 2 is located in the lower position C1, the rotary shaft 35a is also located in the lower position. The U-shaped leaf spring 36 is here not pushed by the rotary shaft 35a. Therefore, the second piece 36b does not push the protruding pin 37a upward, and the switch 37 is in the OFF state. Thus, the switch 37 transmits an ON signal to controller 8 only when the driving nose 2 is in the upper position C2. When the ON signal is transmitted to controller 8, the pulling operation of trigger 5 becomes effective.

As shown in FIGS. 1 to 3, the driving tool 1 has a controller 8 that primarily controls the driving of the electric motor 20. The controller 8 has a control board housed in a shallow-bottomed rectangular box-shaped case. The controller 8 is installed below the motor housing 11a, which accommodates the electric motor 20, and above the magazine 30 in the up-down direction. The controller 8 is housed in the motor housing 11a and gear housing 11b below the electric motor 20. The controller is arranged in a space that is formed between the electric motor 20 and the magazine 30 in the up-down direction by extending the driving nose 2 long downward and setting the stand-by position of the driver 15 closer to the bottom.

As shown in FIGS. 1 to 3 and FIG. 8, the controller 8 is arranged in an orientation with the front-rear direction as the longest side and the up-down direction as the shortest side in the thickness direction. The controller 8 is arranged in an orientation with the upper surface (long side) 8a and the lower surface (long side) 8b aligned along the motor axis direction of the electric motor 20, i.e., the front-rear direction. A space is provided below the electric motor 20 between the upper surface 8a of the controller and the upper surface of the motor housing 11a in the up-down direction. A space is also provided between the lower surface 8b of the controller 8 and the lower surface of the main body housing 11. In these respective spaces above and below the controller 8, an elastic member 9 may be interposed. The elastic member 9 may be made of rubber. The elastic member 9 serves to suppress the transmission of impacts to the controller 8 that occur during driving operation or due to rebound immediately after driving.

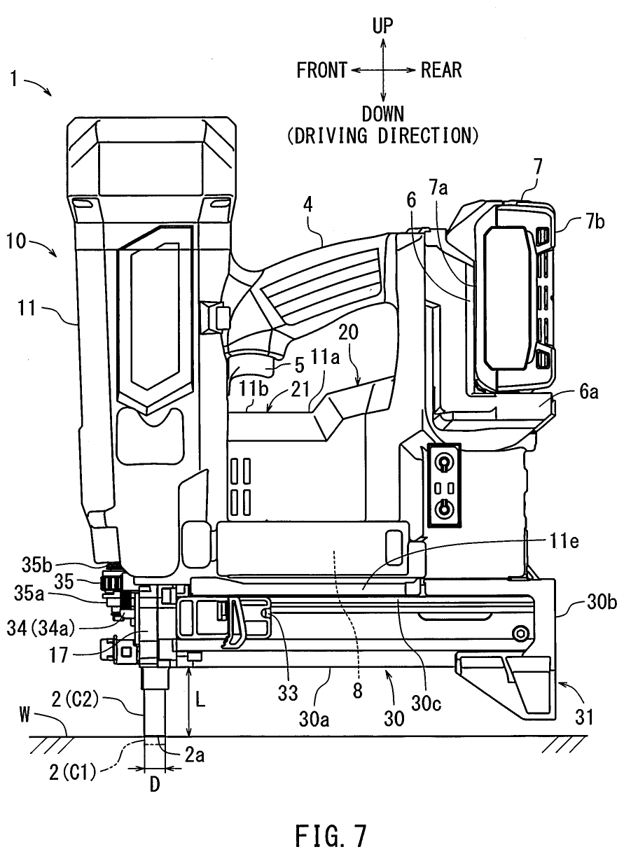

As shown in FIGS. 1 to 3 and FIG. 8, the front side 8c of the controller 8 is arranged in a position to align with the planetary gear reduction mechanism 21 in the front-rear direction. The rear side 8d of the controller 8 is arranged behind the electric motor 20. The left lateral side of the main body housing 11 is provided with a rib-shaped magazine support 11e that extends downward from the housing of the controller 8. The magazine support 11e is provided below the motor housing 11a and the gear housing 11b. The magazine support 11e extends long in the front-rear direction along the lower surfaces of the motor housing 11a and gear housing 11b. A lower surface of the main body housing 11 is in contact with an upper surface of the magazine 30. A right lateral side of the magazine support 11e contacts a left lateral side 30c of the magazine 30 (FIG. 7). The magazine 30 is therefore stabilized in its posture through positioning of the upper surface and lateral side 30c by the main body housing 11.

Hereinafter, a sequence of driving operations of the driving tool 1 will be described with reference to FIGS. 2 to 5. FIGS. 2 and 4 show a standby state of the driver 15. FIGS. 3 and 5 show a state immediately after driving in which the driver 15 has moved to the bottom dead center. The driver 15 in the standby state is stopped at the stand-by position slightly below the top dead center. When the driver 15 is in the stand-by position, the bottom surface of the lowest rack tooth 15a and the last engaging portion 24a of the lift mechanism 22 are engaging. When the driver 15 is in the stand-by position, the end 15b of the driver 15 overlaps in the up-down direction with a head of the frontmost driven member N in the magazine 30. Therefore, the driven member N is not yet fed into the driving channel 3.

When the lower end of the driving nose 2 is pressed against the workpiece W, the driving nose 2 moves from the lower position C1 to the upper position C2. The rotary shaft 35a of the adjuster 35 moves upward in conjunction with the driving nose 2. The switch 37 is turned to the ON state when the protruding pin 37a is pressed via the U-shaped leaf spring 36. The controller 8 starts the electric motor 20 when it receives an electrical signal indicating that the switch 37 is in the ON state and the trigger 5 is pulled. When the electric motor 20 is started, the wheel 23 of the lift mechanism 22 rotates. The last engaging portion 24a moves the lowest rack tooth 15a upward. This causes the driver 15 to move upward from the stand-by position to the top dead center.

As the driver 15 reaches a state immediately before striking at the top dead center, the last engaging portion 24a is removed from the bottom of the lowest rack tooth 15a. This causes the driver 15 to move downward, being biased by the gas pressure within the pressure accumulation chamber 13 that was applied to the piston 14. One of the frontmost driven members N is fed in the driving channel 3 from the magazine 30 while the driver 15 moves upward from the stand-by position to the top dead center. The end 15b of the driver 15 moves downward in the driving channel 3 and strikes the head of the one driven member N. As the driver 15 moves downward, all engaging portions 24 are retracted to the right of the driving channel 3. Therefore, interference between the rack tooth 15a of the downwardly moving driver 15 and the engaging portions 24 is avoided so that a smooth striking operation can be performed.

The wheel 23 continues to rotate as the driver 15 is moving downward and after reaching the bottom dead center. When the driver 15 is at bottom dead center and the wheel 23 rotates to a predetermined angle of rotation, one of the engaging portions 24 engages the bottom of the uppermost rack tooth 15a. This initiates the return motion that causes the driver 15 to move upward. When the last engaging portion 24a engages the bottom of the lowest end rack tooth 15a, the driver 15 returns to the stand-by position. By properly measuring, for example, the time elapsed since the start of the electric motor 20 or by properly measuring the rotation position of the wheel 23, the electric motor 20 is stopped when the piston 14 reaches the stand-by position. As a result, the driver 15 is held in the stand-by position. As described above, the series of driving operations is completed.

As described above, the driving tool 1 includes a tool body 10 having a driver 15 that moves downward to strike a driven member N as shown in FIGS. 2 and 3. The driving tool 1 has a grip 4 extending rearward from the tool body 10. The driving tool 1 has a battery mounting section 6 provided at a rear part of the grip 4 to which a battery 7 can be attached. The driving tool 1 has a motor housing 11a extending rearward from the tool body 10 below the grip 4 to accommodate an electric motor 20 that moves the driver 15. The driving tool 1 has a controller 8 arranged below the electric motor 20 to control an operation of the electric motor 20.

Therefore, the controller 8 is arranged further below the electric motor 20, which is located below the battery mounting section 6. This arrangement makes an area around the battery mounting section 6 more compact than, for example, the conventional structure in which the controller 8 is arranged along a mounting surface 7a of the battery 7 to be attached to the battery mounting section 6. The controller 8 can also be compactly arranged along the lower part of the electric motor 20. Thus, the entire driving tool 1 may be reduced in size in the front-rear direction.

As shown in FIGS. 1 to 3, the upper surface 8a and the lower surface 8b as long sides of a box-shaped controller 8 extend along the front-rear direction. Therefore, it is possible to reduce the size of a driving tool 1 in the front-rear direction while preventing the driving tool 1 from increasing in size in the up-down direction due to the arrangement of the controller 8.

As shown in FIGS. 1 to 3, an elastic member 9 is interposed between both of the upper surface 8a and lower surface 8b of the controller 8 and the motor housing 11a. Thus, the elastic member 9 can protect the controller 8 against impacts, for example, during the driving operation or impacts due to rebound immediately after the driving operation. During or immediately after the driving operation, rebound occurs that causes the tool body 10 to move upward against the controller 8 or the like, which tends to stay in place. Therefore, the impact is mainly transmitted from the lower surface 8b side of the controller 8. By interposing an elastic member 9 on the lower surface 8b side of the controller 8, the impact transmitted to the controller 8 may be suppressed more efficiently.

As shown in FIGS. 2 and 3, the driving tool 1 has a magazine 30 that accommodates driven members N and extends rearward from the lower part of the tool body 10. The controller 8 is arranged between the magazine 30 and an electric motor 20. Therefore, the controller 8 can be arranged in a space between a top of the magazine 30 and a bottom of the electric motor 20. As a result, the area around the battery mounting section 6 can be made compact.

As shown in FIGS. 1 to 3, a rear surface 30b of the magazine 30 is positioned flush with or in front of a rear surface 7b of the battery 7 attached to the battery mounting section 6. Therefore, the area around the battery 7 to be attached to the battery mounting section 6 may be made compact in the front-rear direction. For example, even if the battery 7 protrudes rearward from the rear surface 30 of the magazine 30, a controller 8 is not provided around the battery mounting section 6. Therefore, it is possible to achieve compactness in the front-rear direction, for example, by reducing the protrusion of the battery 7.

As shown in FIGS. 2 and 3, a driving nose 2 is provided at a lower part of the tool body 10 so as to be movable in the up-down direction, which has an ejection port 2a for driven members N. The driving nose 2 protrudes downward from the magazine 30 by 40 mm or more when in an upper position. Therefore, for example a long driving nose 2 can be inserted into a groove when driving driven members N into a bottom of the groove. This makes it possible to improve the handling property of the driving tool 1.

As shown in FIGS. 1 to 3, the driving nose 2 has a width (diameter D) of 15 mm or less in at least one direction. Thus, for example, when driving driven members N into the bottom of a narrow groove, the nose 2 with a narrow width can be inserted into the groove. This configuration enhances the handling property of the driving tool 1.

As shown in FIG. 7, the driving tool 1 has a magazine support 11e that extends from the motor housing 11a along a lateral side 30c of the magazine 30. Therefore, the lateral side 30c of the magazine 30 can be supported by the magazine support 11e. This configuration provides a stable support for the magazine 30 that is long in the front-rear direction.

As shown in FIGS. 2 and 3, the tool body 10 is provided with a piston 14 that moves downward together with the driver 15 due to the gas pressure within the cylinder 12. The tool body 10 is provided with a lift mechanism 22 that moves the driver 15 upward to increase the gas pressure. Therefore, the controller 8 may be compactly arranged in a so-called gas spring type driving tool 1.

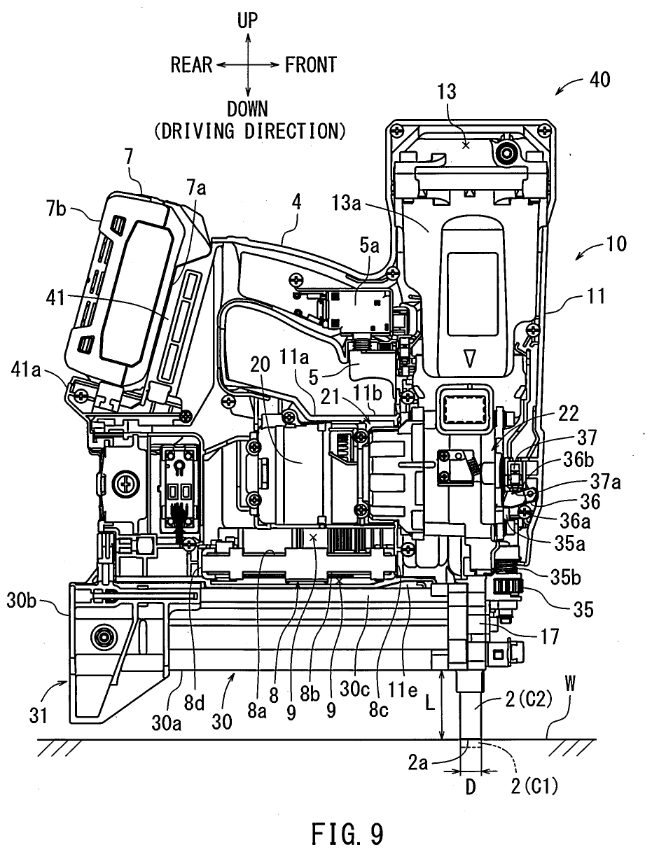

Hereinafter, a second embodiment will be described with reference to FIG. 9. A driving tool 40 according to a second embodiment includes a battery mounting section 41 instead of the battery mounting section 6 shown in FIG. 1. In the following description, only the parts that differ from the first embodiment will be described in detail.

As shown in FIG. 9, a battery 7 can be removably attached to the battery mounting section 41. The mounting surface 7a of the battery 7 attached to the battery mounting section 41 is inclined with respect to the driving direction. Specifically, the mounting surface 7a is inclined forward and upward, i.e., inclined forward toward the upper direction. The rear surface 7b of the battery 7 is also inclined forward and upward. The battery mounting section 41 has a lower portion 41a that faces the lower surface of the battery 7. The lower portion 41a extends in a direction substantially orthogonal to the mounting surface 7a. The lower portion 41a is inclined upward toward the rear direction. The rear surface 30b of the magazine 30 is aligned up and down at substantially the same front-rear position with the rearmost end of the rear surface 7b of the battery 7 and the rear end of the lower portion 41a, and does not project at least behind the rearmost end of the rear surface 7b.

As described-above, the rear surface 7b of the battery 7 attached to the battery mounting section 41 is inclined forward and upward. Therefore, the flexibility of the battery mounting section 41 can be increased by arranging the controller 8 below the electric motor 8. Therefore, when placing the driving tool 40 in a position where the rear surface 7b of the battery 7 is in contact with the ground and the front lower part of the driving nose 2 is oriented toward the top side, interference between the rear end of the magazine 30 and the ground contact surface can be prevented. This configuration makes it possible to improve the handling property of the driving tool 40.

Various modifications may be made to the driving tool 1 and 40 in each of the embodiments described above. The gas spring type driving tool 1 and 40 has been exemplary described in the embodiments. Instead, the present disclosure may be applied to a mechanical spring-type driving tool that ejects a driver using a spring force of a mechanical compression spring, generated, for example, when the driver is moved in the counter-driving direction by a lift mechanism. For example, the present disclosure may also be applied to a flywheel type driving tool that uses the inertial force of the flywheel to eject the driver. For example, the present disclosure may be applied to an electro-pneumatic driving tool that uses compressed air generated by rotating a crank by an electric motor.

While a nail was described as an example of a driven member N, it may be, for example, a driving tool capable of ejecting a U-shaped staple. A workpiece W made of concrete, has been described as an example as a target object into which the driven member N can be driven. Instead, a workpiece made of wood, for example, may be used as a target object.

A configuration has been described as an example in which the driving nose 2 also serves as the contact arm. Alternatively, it may have such a configuration provided with a driving nose that does not move in the up-down direction and a contact arm that is separated from the driving nose and can move in the up-down direction. A cylindrical driving nose 2 has been described in the embodiment. Instead, for example, the driving nose may have a rectangular cylindrical shape, an elliptical tubular shape, or the like. The driving nose may have a width of 15 mm or less in at least one direction. For example, the driving nose may have a width of 15 mm or less in the front-rear direction or in the left-right direction.

A magazine 30 extending straight rearward from the driver guide 17 has been described in the embodiment. Alternatively, for example, the magazine may be slanted in either left or right direction as it moves rearward from the driver guide 17. The magazine support 11e along the left lateral side 30c of the magazine 30 has been described in embodiments. Alternatively, or in addition, a magazine support along the right lateral side 30c of the magazine 30 may be provided in the main body housing 11.

The controller 8 has been described in the embodiments with the upper surface 8a and lower surface 8b extending straight in the front-rear direction along the motor axis of the electric motor 20. Instead, the controller 8 may, for example, be inclined upward or downward with respect to the motor axis while extending in a substantially front-rear direction. Alternatively, the controller 8 may, for example, be inclined to the left or right while extending in the substantially front-rear direction.

In the embodiments, a configuration has been described in which each elastic member 9 is interposed between the upper surface 8a of the controller 8 and the upper surface of the motor housing 11a, and between the lower surface 8b and the lower surface of the main body housing 11. Instead, the elastic member 9 may be interposed in only one of these spaces. By interposing each elastic member 9 in both spaces, it is possible to further suppress the transmission of impact to the controller 8.

What is claimed is:

1. A driving tool comprising:
a tool body having a driver configured to move downward to strike a driven member;
a grip configured to extend rearwardly from the tool body;
a battery mounting section located at a rear part of the grip and configured to attach a battery;
a motor housing configured to extend rearwardly from the tool body below the grip to accommodate an electric motor to move the driver; and
a controller located below the electric motor and configured to control an operation of the electric motor.

2. The driving tool according to claim 1, wherein a long side of the controller with a box-shape extends along a front-rear direction.

3. The driving tool according to claim 1, further comprising an elastic member wherein the elastic member is interposed between either one of or both of upper and lower surfaces of the controller and the motor housing, and wherein the elastic member is configured to suppress impacts of the controller.

4. The driving tool according to claim 1, further comprising a magazine for accommodating the driven members, and wherein the magazine extends rearward from a lower part of the tool body, and wherein the controller is arranged between the magazine and the electric motor.

5. The driving tool according to claim 4, wherein the magazine has a rear surface that is positioned flush with or in front of a rear surface of the battery that is attachable to the battery mounting section.

6. The driving tool according to claim 4, further comprising a nose located at a lower part of the tool body to move in an up-down direction, wherein the nose has an ejection port, and
wherein the nose protrudes downward from the magazine by about 40 mm or more in an upper position.

7. The driving tool according to claim 6, wherein the nose has a width of about 15 mm or less in at least one direction.

8. The driving tool according to claim 4, further comprising a magazine support, and wherein the magazine support extends from the motor housing along a lateral side of the magazine.

9. The driving tool according to claim 1, wherein a rear surface of the battery attached to the battery mounting section is inclined forward and upward.

10. The driving tool according to claim 1, wherein the tool body has a piston configured to move downward together with the driver due to gas pressure within a cylinder.

11. The driving tool according to claim 10, wherein the tool body has a lift mechanism configured to move the driver upward to increase the gas pressure in the cylinder.

12. A driving tool comprising:
a tool body having a driver configured to move downward to strike a driven member;
a grip configured to extend rearwardly from the tool body;
a battery mounting section located at a rear part of the grip and configured to attach a battery at a mounting surface, the mounting surface is inclined to a driving direction;
a motor housing configured to extend rearwardly from the tool body below the grip to accommodate an electric motor to move the driver;
a magazine having a lower surface that extends in a front-rear direction and a rear surface that extends in an up-down direction; and
a controller located below the electric motor and configured to control an operation of the electric motor.

13. The driving tool according to claim 12 further comprising a planetary gear reduction mechanism coupled to the electric motor, wherein the planetary gear reduction mechanism is located at a front of the electric motor.

14. The driving tool according to claim 13 further comprising a lift mechanism located at a front of the planetary gear reduction mechanism.

15. The driving tool according to claim 14, wherein the planetary gear reduction mechanism and the lift mechanism are arranged in an alignment on a motor axis of the electric motor.

16. The driving tool according to claim 12, wherein the controller is arranged to locate between the magazine and the electric motor.

17. The driving tool according to claim 12, wherein the battery mounting section has a lower portion extending in an orthogonal direction to the mounting surface.

18. The driving tool according to claim 12, wherein the battery is configured to attach to a rear surface of the battery mounting section, and wherein the rear surface is inclined forward and upward.
